(19) United States
(12) Patent Application Publication
(10) Pub. No.: US 2021/0225199 A1
(43) Pub. Date: Jul. 22, 2021

(54) ARTIFICIAL INTELLIGENCE-BASED ENGLISH TRAINING METHOD

(71) Applicant: I hate flying bugs Co., Ltd., Seoul (KR)

(72) Inventor: Chan Yong PARK, Seoul (KR)

(21) Appl. No.: 16/822,594

(22) Filed: Mar. 18, 2020

(30) Foreign Application Priority Data
Jan. 22, 2020 (KR) 10-2020-0008873

(51) Int. Cl. G09B 19/06; G09B 7/04; G06K 9/62

(52) U.S. Cl. CPC G09B 19/06; G06K 9/6264; G06K 9/6265; G09B 7/04

(57) ABSTRACT

An artificial intelligence-based English training method invention involves a server providing an English training content to a learner and a device displaying the English training content provided from the server. The method includes collecting initial training data of the device, staging the collected initial training data, providing a training content suitable for proficiency and relevance of training to the device on the basis of the staged training data, transmitting an answer to the provided training content to the server and calculating training data at the server through a statistical algorithm based on the answer provided from the device, and graphing data after training on the basis of the calculated data to be displayed on the device, whereby the current training state can be displayed in more detail, by calculating the data according to the training result and displaying the graph thereof on the device.

### CROSS REFERENCE TO RELATED APPLICATION

The present application claims priority to Korean Patent Application No. 10-2020-0008873, filed on Jan. 22, 2020, the entire contents of which is incorporated herein for all purposes by this reference.

### BACKGROUND OF THE INVENTION

### 1. Field of the Invention

The present invention relates to an artificial intelligence-based English training method. More specifically, the present invention relates to an artificial intelligence-based English training method that determines the current training state of a learner and provides English training contents suitable for the training state of a learner.

### 2. Background Art

In general, foreign language textbooks are provided in such a manner that those who wish to study foreign languages are look at and memorize corresponding sentences in a specific textbook which may consist of, for example, books made for training English and audio tapes to supplement the books as needed.

That is, an artificial intelligence-based English training method in the related art is to memorize words or sentences through repetitive training. For example, the training proceeds in such a manner that a user listens, reads, repeats, writes, and memorizes sentences written in English. Patent Document 1 discloses a word memorization training textbook that enables a user to easily and widely understand various meanings of foreign language words, and enhances the effect of memorization. Patent Document 2 discloses a training method excellent in English word memorization effect and is provided in such a manner that a user can memorize English words by naturally recalling what he/she has learned in real life when applying a word memorization method and a user doesn't easily forget the pictures of the entire book by applying a unique memory reminder.

However, since these technologies in the related art merely provide training textbooks for memorizing words or training instructions for memorizing words, there is a problem of providing English training instruction regardless of the training state of the learners.

### SUMMARY

Accordingly, the present invention has been made keeping in mind the above problems occurring in the related art.

An aspect of the present invention is to provide an artificial intelligence-based English training method, which collects the current training data of a learner and provides English training suitable for a training state of a learner.

One or more embodiments of the present invention provides an artificial intelligence-based English training method, the method involving a server providing an English training content to a learner and a device displaying the English training content provided from the server, the method including: collecting initial training data of the device; staging the collected initial training data; providing a training content suitable for proficiency and relevance of training to the device on the basis of the staged training data; transmitting an answer to the provided training content to the server and calculating training data at the server through a statistical algorithm on the basis of the answer provided from the device; and graphing data after training on the basis of the calculated data to be displayed on the device.

In the artificial intelligence-based English training method according to an embodiment of the present invention, the collecting of the initial training data may include receiving existing training data learned by a previous learner from the server; and setting a weight on the basis of the training data to be selectively applied to the initial training data.

In the artificial intelligence-based English training method according to an embodiment of the present invention, the staging of the initial training data may include a status −2 including a status in which the training is completed, the training being limited to training contents provided by the server; a status −1 including a status in which the training contents are first exposed to the device with the training being not completed, the training being limited to training contents provided by the server; a status 0 including a training content not exposed to the device; a status 1 including a status in which the training is performed once with the training being not completed, the training being limited to training contents provided by the server; a status n including a status in which the training is performed n times with the training being not completed, the training being limited to training contents provided by the server.

In the artificial intelligence-based English training method according to an embodiment of the present invention, the providing of the training content may include: segmenting the training content to be provided to the device for each word; and assigning one of the statuses −2, −1, 0, 1, and n to each training content for each word.

In the artificial intelligence-based English training method according to an embodiment of the present invention, the calculating of the training data may include calculating the training state of the device on the basis of time, memory rate, and number of repetition times.

In the artificial intelligence-based English training method according to an embodiment of the present invention, the graphing of the data may include selecting at least one of an English word, a grammar, a vocabulary, and a reading from among the training contents provided by the server to be graphed.

In the artificial intelligence-based English training method according to an embodiment of the present invention, the collecting of the initial training data may include providing, to the device, a training content to which a level is assigned from the server; training the training content provided from the server through the device; determining whether an answer to the training content is correct or incorrect, to provide a training content corresponding to the correct answer or the incorrect answer to the device; repeatedly providing the training content the number of times predetermined in the device; and calculating an initial training result on the basis of the correct answer or the incorrect answer provided by the device.

In the artificial intelligence-based English training method according to an embodiment of the present invention, the providing of the training content may include providing a level sequentially starting from a level 1 to the device or providing one level selected from among levels 1 to 9 to the device, when assigning a range of level 1 to level 9 to the training content provided by the server.

The artificial intelligence-based English training method according to an embodiment of the present invention may further include requesting, from the server, a training content having one level higher than a current level of the training content provided from the server, when the answer to the training content is correct in the determining whether the answer to the training content is correct or incorrect.

The artificial intelligence-based English training method according to an embodiment of the present invention may further include re-requesting a training content having the same level as a current level of the training content provided from the server, when the answer to the training content is incorrect in the determining whether the answer to the training content is correct or incorrect.

In the artificial intelligence-based English training method according to an embodiment of the present invention, the providing of the training content may include requesting current training data of the device from the server; requesting training content of the same level as a training level of the device from the server; training the training content requested from the server; transmitting an answer to the training content to the server, determining whether the answer is correct or incorrect at the server, and recording a result thereof; determining whether all training contents of the same level as the training level of the device are trained; and selecting whether to perform next training level or to complete the training.

In the artificial intelligence-based English training method according to an embodiment of the present invention, the requesting of the training content of the same level may include providing a training content of high relevance from the server or providing one selected from training contents for which the training is not completed, among training contents first provided by the device, when requesting training contents of the same level as the training level of the device.

In the artificial intelligence-based English training method according to an embodiment of the present invention, a selection ratio of training contents having high relevance and training contents for which the training is not completed may be selected within a range of 8:2 to 9:1, the selection range being predetermined in the server.

In the artificial intelligence-based English training method according to an embodiment of the present invention, the determining whether all training contents of the same level as the training level of the device are trained may include determining that all training contents of the same level as a training level of the device are trained when there is no training content that is not exposed, among training contents of the same level as the training level of the device; and assigning one level higher than the training level given to the device, when the determination is made.

In the artificial intelligence-based English training method according to an embodiment of the present invention, when the next training level is selected in the selecting of whether to perform next training level or to complete the training, one level higher than the training level assigned to the device may be requested from the server to rematch a training content of the same level as a level requested from the server, and the rematched training content is provided to the device.

In the artificial intelligence-based English training method according to an embodiment of the present invention, when the training is completed in the selecting of whether to perform next training level or to complete the training, a learner's training state may be calculated as data or a graph through a statistical algorithm on the basis of the correct answer or the incorrect answer, and the calculated data or graph is displayed on the device.

Such solutions will become more apparent from the following detailed description of the invention based on the accompanying drawings.

Prior to this, the terms or words used in the specification and claims should not be construed in the usual and dictionary sense. It should be interpreted as having meanings and concepts corresponding to the technical spirit of the present invention, on the basis of the principle that an inventor can properly define the concept of a term in order to describe his invention in the best possible way.

According to an embodiment of the present invention, training efficiency may be maximized by segmenting training data into each training state according to the current training state and providing suitable training contents on the basis of the segmented data.

Further, according to an embodiment of the present invention, by separately calculating the data according to the training result and displaying the graph (or forgetting curve) thereof on the device, the current training state can be displayed in more detail.

### BRIEF DESCRIPTION OF THE DRAWINGS

The above and other aspects, features, and other advantages of the present invention will be more clearly understood from the following detailed description when taken in conjunction with the accompanying drawings, in which:

FIG. 1 is a flow chart showing an artificial intelligence-based English training method according to an embodiment of the present invention;

FIG. 2 is a flowchart illustrating a method of collecting initial training data according to an embodiment of the present invention;

FIG. 3 is a flow chart illustrating a method of providing English training content according to an embodiment of the present invention; and

FIGS. 4A to 4C are graphs illustrating training results of an artificial intelligence-based English training method according to an embodiment of the present invention.

### DETAILED DESCRIPTION

Specific aspects and specific technical features of the present invention will become more apparent from the following detailed description and embodiments related to the accompanying drawings. In the present specification, in adding reference numerals to components of each drawing, it should be noted that the same reference numerals are used to refer to like elements even though they are shown in different drawings. In addition, in describing an embodiment of the present invention, when it is determined that the detailed description of the related well-known configuration or function may obscure the gist of the present invention, the detailed description thereof will be omitted.

In addition, in describing the components of the present invention, terms such as first, second, A, B, (a), and (b) may be used. These terms are only to distinguish the components from other components, and the nature, order, etc. of the components are not limited by the terms. If a component is described as being “connected”, “coupled”, or “attached” to other component, the component may be directly connected or connected to the other component, but it is to be understood that another component may be “connected”, “coupled”, or “attached” between each component.

Hereinafter, an embodiment of the present invention will be described in detail with reference to the accompanying drawings.

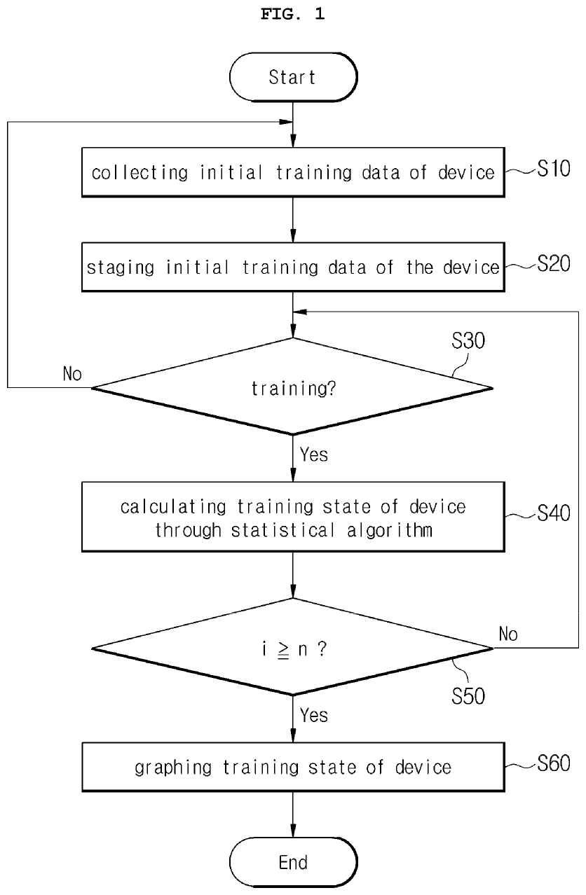

As shown in FIG. 1, according to an embodiment of the present invention, an artificial intelligence-based English training method is performed using a server that stores at least one English training content and provides English training contents to the learner and a device that receives the English training contents from the server and displays the same to a user.

The device is a product that allows a learner to watch the English training content, and may include a smartphone, a PC, a tablet, and an iPad, which may be connected to a server via wired or wireless communication.

The artificial intelligence-based English training method includes collecting an initial training data of the device (S10); staging the collected initial training data (S20);

providing a training content suitable for proficiency and relevance of training to the device on the basis of the staged training data (S30); receiving training data from the device through a statistical algorithm and calculating the same (S40); and graphing the calculated data to be displayed on the device (S50).

First, the initial training data may be collected from the server to determine the training state of the learner before the learner learns the English training contents through the device (S10), and the specific method thereof will be described later.

After collecting the initial training data using the above method, a weight may be calculated on the basis of the existing training data previously stored in the server and learned by the previous learners, and may be selectively applied to the initial training data, but the present invention is not limited thereto.

For example, assuming that a separate test is performed to collect the initial training data, when a question with relatively low difficulty is not answered and a question with relatively high difficulty is answered, the method according to the present invention may be configured to correct the initial training data by applying the weight thereof. On the contrary, when a question with relatively low difficulty is answered and a question with relatively high difficult is not answered, the method may be configured to output the initial training data without applying a weight.

After collecting the learner's initial training data in this manner, the training contents may be staged (or segmented) on the basis of the collected initial training data (S20).

Specifically, the initial training data may be segmented into at least five stages, which may include status −2, status −1, status 0, status 1, and status n.

The status −2 includes a status in which a learner completes learning the training content, the training being limited to training contents provided by the server, and when the learner completes training the corresponding training contents, the corresponding status may be given.

The status −1 includes a status in which the training contents are first exposed (or provided) to a device with the training being not completed, the training being limited to training contents provided by the server. When the learner is provided with the training contents for the first time and learns the training contents once, the corresponding status may be given.

The status 0 includes a status that includes training content that has never been exposed to the device, and when the device is not provided with the training content by the server, the corresponding status may not be given.

The status 1 includes a status in which a learner completes learning the training content once, the training being limited to training contents provided by the server, and when the learner has learned the training contents through one-time training, the corresponding status may be given.

Herein, the status −1 and the status 1 are the same as each other in that the training content is provided once from the server. However, the status −1 and the status 1 are different from each other in that the status −1 is given, for example, when the learner has not completed training even through one-time training, and the status 1 may be given, for example, when the learner has not completed training through one-time training. The status n may include a status in which the training has been performed n times with the training being not completed, the training being limited to training contents provided by the server. For example, a status 2 may be given when the learner has not learned the content even after going through the same twice, and the status 5 may be given when the learner has not learned the content even after going through the same five times.

Step-by-step statuses including statuses −2, −1, 0, 1, and n are provided so that the training content provided from the server may be partitioned for each word, and one of statuses −2, −1, 0, 1, and n may be given to each of the words.

For example, assuming that the training content to be learned is an English sentence, “He is very nice”, for example, statuses ‘−2’, ‘−2’, ‘−1’, and ‘1’ are applied to ‘he’, ‘is’, ‘very’, and ‘nice’, respectively. For example, when the sentence has never been exposed to the leaner, statuses ‘0’, ‘0, ‘0’, and ‘0’ may be given.

Although the above example has been described as being applied to each sentence, the present invention is not limited thereto, but may be applied to grammar, words, vocabulary, reading, and training content provided from a server, and in particular, may easily provide staging of the initial training data, by applying the status to the training content provided from the server.

The server collecting information on the initial training state calculates the training content suitable for the proficiency of and relevance to the learner on the basis of the collected information, and then provides the training content to the device (S30). The method of providing the content suitable for the learner's training level will be described in detail later.

When providing the training content to the device, the device transmits, to the server, an answer to the question contained in the training content, so that the server may determine whether the answer provided from the device is correct or incorrect, and then classify and record the same.

At least one or more training contents may be provided to the device, in which the device may repeatedly receive the training content up to a preset number of times, or may sequentially receive the training content selected in advance (S50).

After the training content is provided in this manner, the training data may be calculated through a statistical algorithm on the basis of whether the recorded answer is a correct or incorrect answer (S40). Specifically, the training data may be calculated on the basis of the data collected by the device, for example, time to learn, memory rate, and repetition frequency.

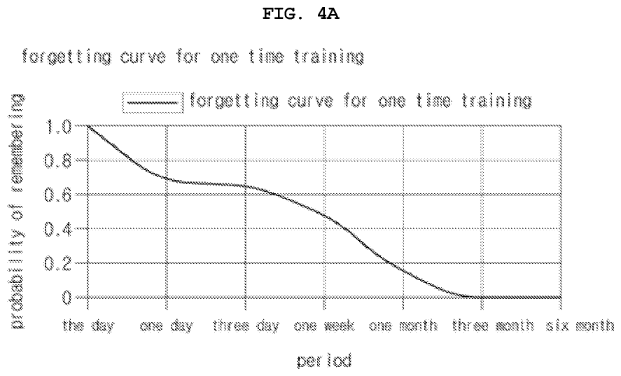

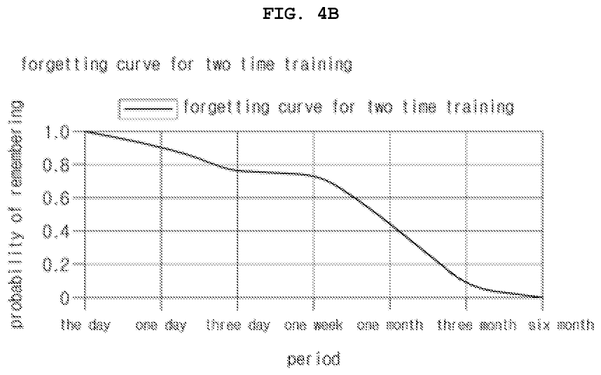

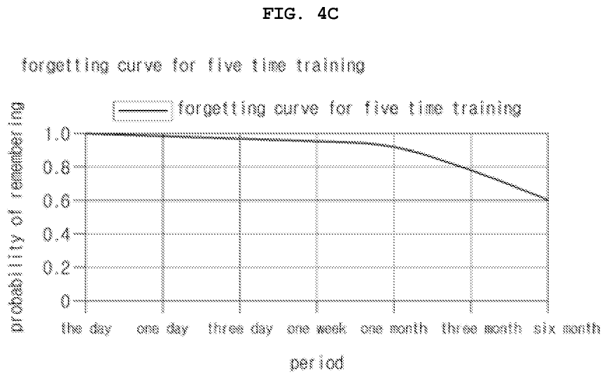

After the training data is calculated and graphed, the data is displayed on the device. As illustrated in FIGS. 4A to 4C, a period capable of storing the training through the training content, for example, a forgetting curve, may be displayed on the device (S60).

In addition, as illustrated in FIGS. 4A to 4C, the forgetting curve may be provided according to how many times the corresponding training content has been learned, and the forgetting curve may be differently provided according to the learner's training state.

In addition, the above-mentioned forgetting curve (graph) includes training content provided by the server. More specifically, at least one of an English word, grammar, vocabulary, and reading may be selected and displayed as a forgetting curve (graph).

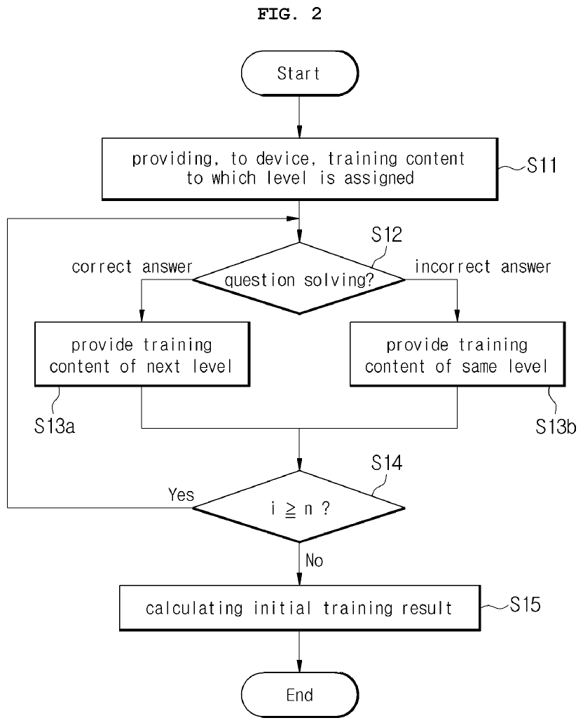

As shown in FIG. 2, the collecting of the initial training data includes: providing, to the device, training content to which a level is assigned from the server (S11); training the training content provided from the server through the device (S12); determining whether an answer to the training content is correct or incorrect, to provide training content corresponding to the correct answer or the incorrect answer to the device (S13); repeatedly providing the training content the number of times predetermined in the device (S14); and calculating an initial training result on the basis of the correct answer or the incorrect answer provided by the device (S15).

The device may request the training content to which a level is assigned, from the server, and the server may provide the training content to the device (S11).

In detail, the server may previously assign a level to the training content from a level 1 to a level 9, and provide one of the training contents to which the level is assigned to the device.

In addition, the training contents may be provided to the device sequentially from the level 1 to the level 9, or may be provided to the device by arbitrarily selecting one level from level 1 to level 9 and selecting one of functions provided to the device, the selection being made via the device. When the level is not selected by the device, the device may be provided sequentially starting from level 1.

The device provided with the training content from the server may learn the training content, and may input an answer to a question provided by the training content (S12). The input answer is transmitted to the server, and the server may determine whether the answer is correct or incorrect, in which the data for the correct answer or the incorrect answer may be recorded separately in the server.

After determining the correct answer or the incorrect answer, the server may provide the training content corresponding to the correct answer or the incorrect answer to the device (S13).

Specifically, for example, when the answer input from the device is correct, a training content of one level higher than the current level of the training content provided by the server may be requested from the server. For example, when the answer input from the device is incorrect, a training content of the same level as the current level of the training content provided from the server may be requested from the server.

For example, when training the training content of level 2, when the answer is correct, the training content of level 3 may be requested, and when the answer is incorrect, the training content of level 2 may be requested again. Herein, when requesting a training content of the same level, the remaining training contents of the same level except for the training content previously requested may be provided to the device.

By repeatedly performing the steps S12 and S13, the training contents may be repeatedly provided so that answers to the training contents are recorded in the server (S14). Here, the number of repetition times that the training content is provided may be predetermined by the device.

Thereafter, the server may calculate the initial training result on the basis of the correct answer or the incorrect answer, and display the training result on the device.

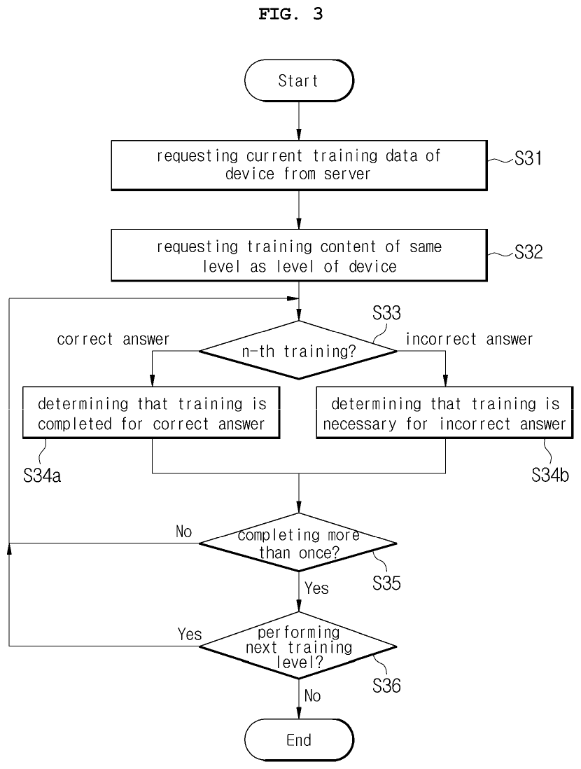

As shown in FIG. 3, the providing of the training content includes: requesting current training data of the device from the server (S31); requesting training content of the same level as the training level of the device from the server (S32); training the training content requested from the server (S33); transmitting an answer to the training content to a server, determining whether the answer is correct or incorrect at the server, and recording a result thereon (S34); determining whether all the training contents of the same level as the training level of the device has been learned (S35); and selecting whether to perform next training level or to complete the training (S36).

First, the device may request the current training data of the device from the server to load the current training data of the device in the server (S31). After determining the current training level of the device among the learned data of the loaded device, the server may search for the training content of the same level as the current training level of the device, and then provide the training content to the device (S32).

When providing the training content to the device, the training content of the same level as the training level of the device may be requested. Herein, the training content having high importance may be provided from the server, or one of the training contents for which the training has not been completed among the training contents initially provided by the device may be arbitrarily selected and provided from the server.

Here, the training content for which the training has not been completed may include a training content that is given the status −1 or the status 1, which is segmented in the staging of the training contents S20.

In addition, a selection ratio of the training content having high importance and the training content for which the training has not been completed may be selected within a range of 8:2 to 9:1, the selection range being predetermined in the server.

In addition, the ratio of the training content having high importance and the training content for which the training has not been completed may be proportionally adjusted according to the number of training times of the training content.

Specifically, when the first training for the training content is performed (S33), the selection ratio of the training content of high importance and the training content for which the training has not been completed may be adjusted to 8:2. When the secondary training for the training content is performed (S33), the selection ratio of the training content having high importance and the training content for which the training has not been completed may be adjusted to 9:1. Thereafter, when the n-th training is repeatedly performed, the ratio may be adjusted up to a maximum of 9.5:0.5, and the adjustment ratio may be adjusted in the server as described above.

Thereafter, the device may learn the training content provided from the server (S33). In detail, the device may learn the training content provided from the server, and input an answer to a question included in the training content, in which the input answer may be transmitted to the server.

The server may determine whether the answer received from the device is correct or incorrect, and record the result to collect the training result for the training content (S34).

Herein, when the answer received from the device is correct, the server may determine that the training has been completed only for the training content to which the answer is corrected (S34a). On the contrary, when the answer received from the device is incorrect, the server may determine that the training is required only for the training content to which the answer is incorrect (S34b).

The training content for which it is determined that the training has been completed may be given a status −2 from the server as described in the staging of the training contents S20, and the training content for which it is determined that the training is required may be given a status n from the server. Here, n denotes the number of repetition times of the training content.

In this way, when the training for all the training contents of the same level as the training level of the device has been completed, it is determined whether all training contents provided by the server (specifically, all the training contents of the same level as the training level of the device provided by the server) have been learned (S35). For example, when it is determined that the training has not been completed, the training may be performed repeatedly until it is determined that all training has been completed.

Subsequently, when it is determined that the training for all the training contents has been completed, the device may be additionally given one level higher than the training level previously given to the device, and may further determine whether to proceed to the next training level (S36).

For example, when the device determines to proceed to the next training level, the device may request the training content of the same level as the level given previously from the server, and the server may provide the training content to the device.

For example, when the device determines that the training has been completed, the training state of the learner is calculated through a statistical algorithm on the basis of whether the answer recorded in the server is correct or incorrect, and data or graph thereon to be displayed on the device may be calculated and displayed. Here, the data to be displayed on the device may include guide information on the training state, and the graph to be displayed on the device may include a forgetting curve after the training.

That is, according to an embodiment of the present invention, the current training data is segmented into each status and suitable training content is provided on the basis of the segmented data, thereby maximizing the training efficiency.

Further, according to an embodiment of the present invention, the data is calculated according to the training result and the graph (or forgetting curve) according to the device is displayed on the device, thereby displaying the training state in more detail.

Although the present invention has been described in detail through an embodiment, this is provided for describing the present invention in detail, and the vehicle remote control system according to the present invention is not limited thereto. Terms “comprise”, “configure”, or “have” described above mean that a corresponding component may be included unless specifically stated to the contrary, and therefore, it should be construed that the terms do not exclude other components, but further include other components. All terms including technical or scientific terms have the same meaning as to be generally understood by one of ordinary skill in the art unless otherwise defined

In addition, the above description is merely illustrative of the technical idea of the present invention, and those skilled in the art may make various modifications and variations without departing from the essential characteristics of the present invention. Therefore, the embodiments disclosed in the present invention are not intended to limit the technical spirit of the present invention but to describe the present invention, and the scope of the technical idea of the present invention is not limited by the one embodiment. The protection scope of the present invention should be interpreted by the following claims, and all technical ideas within the scope equivalent thereto should be construed as being included in the scope of the present invention.

What is claimed is:

1. An artificial intelligence-based English training method, the method involving a server providing an English training content to a learner and a device displaying the English training content provided from the server, the method comprising:
collecting initial training data of the device;
staging the collected initial training data;
providing a training content suitable for proficiency and relevance of training to the device on the basis of the staged training data;
transmitting an answer to the provided training content to the server and calculating training data at the server through a statistical algorithm on the basis of the answer provided from the device; and
graphing data after training on the basis of the calculated data to be displayed on the device.

2. The method of claim 1, wherein the collecting of the initial training data comprises:
receiving existing training data learned by a previous learner from the server; and
setting a weight on the basis of the training data to be selectively applied to the initial training data.

3. The method of claim 1, wherein the staging of the initial training data comprises:
a status −2 including a status in which the training is completed, the training being limited to training contents provided by the server;
a status −1 including a status in which the training contents are first exposed to the device with the training being not completed, the training being limited to training contents provided by the server;
a status 0 including a training content not exposed to the device;
a status 1 including a status in which the training is performed once with the training being not completed, the training being limited to training contents provided by the server;
a status n including a status in which the training is performed n times with the training being not completed, the training being limited to training contents provided by the server.

4. The method of claim 3, wherein the providing of the training content comprises:
segmenting the training content to be provided to the device for each word; and
assigning one of the statuses −2, −1, 0, 1, and n to each training content for each word.

5. The method of claim 1, wherein the calculating of the training data comprises calculating the training state of the device on the basis of time, memory rate, and number of repetition times.

6. The method of claim 1, wherein the graphing of the data comprises selecting at least one of an English word, a grammar, a vocabulary, and a reading from among the training contents provided by the server to be graphed.

7. The method of claim 1, wherein the collecting of the initial training data comprises:
providing, to the device, a training content to which a level is assigned from the server;
training the training content provided from the server through the device;
determining whether an answer to the training content is correct or incorrect, to provide a training content corresponding to the correct answer or the incorrect answer to the device;
repeatedly providing the training content the number of times predetermined in the device; and
calculating an initial training result on the basis of the correct answer or the incorrect answer provided by the device.

8. The method of claim 7, wherein the providing of the training content comprises providing a level sequentially starting from a level 1 to the device or providing one level selected from among levels 1 to 9 to the device, when assigning a range of level 1 to level 9 to the training content provided by the server.

9. The method of claim 7, further comprising:
requesting, from the server, a training content having one level higher than a current level of the training content provided from the server, when the answer to the training content is correct in the determining whether the answer to the training content is correct or incorrect.

10. The method of claim 7, further comprising:
re-requesting a training content having the same level as a current level of the training content provided from the server, when the answer to the training content is incorrect in the determining whether the answer to the training content is correct or incorrect.

11. The method of claim 1, wherein the providing of the training content comprises:
requesting current training data of the device from the server;
requesting training content of the same level as a training level of the device from the server;
training the training content requested from the server;
transmitting an answer to the training content to the server, determining whether the answer is correct or incorrect at the server, and recording a result thereof;
determining whether all training contents of the same level as the training level of the device are trained; and
selecting whether to perform next training level or to complete the training.

12. The method of claim 11, wherein the requesting of the training content of the same level comprises:
providing a training content of high relevance from the server or providing one selected from training contents for which the training is not completed, among training contents first provided by the device, when requesting training contents of the same level as the training level of the device.

13. The method of claim 12, wherein a selection ratio of training contents having high relevance and training contents for which the training is not completed is selected within a range of 8:2 to 9:1, the selection range being predetermined in the server.

14. The method of claim 12, wherein the determining whether all training contents of the same level as the training level of the device are trained comprises:
determining that all training contents of the same level as a training level of the device are trained when there is no training content that is not exposed, among training contents of the same level as the training level of the device; and
assigning one level higher than the training level given to the device, when the determination is made.

15. The method of claim 14, wherein when the next training level is selected in the selecting of whether to perform next training level or to complete the training, one level higher than the training level assigned to the device is requested from the server to rematch a training content of the same level as a level requested from the server, and the rematched training content is provided to the device.

16. The method of claim 11, wherein when the training is completed in the selecting of whether to perform next training level or to complete the training, a learner's training state is calculated as data or a graph through a statistical algorithm on the basis of the correct answer or the incorrect answer, and the calculated data or graph is displayed on the device.
